(19) United States
(12) Patent Application Publication
(10) Pub. No.: US 2024/0363028 A1
(43) Pub. Date: Oct. 31, 2024

(54) SURGICAL TRAINING MODEL

(71) Applicant: FUSETEC 3D PTY LTD, Adelaide (AU)

(72) Inventors: Mark ROE, Adelaide (AU); Sammuel SOBEY, Adelaide (AU); Nicholas LITCHFIELD, Adelaide (AU)

(21) Appl. No.: 18/292,958

(22) PCT Filed: Jul. 29, 2022
(86) PCT No.: PCT/AU2022/050803

§ 371 Date: Jan. 29, 2024

(30) Foreign Application Priority Data
Jul. 29, 2021 (AU) 2021902330

(51) Int. Cl. G09B 23/34; G09B 23/32

(52) U.S. Cl. CPC G09B 23/34; G09B 23/32

(57) ABSTRACT

A surgical training model is provided comprising a plurality of removable spacer cassettes that when arranged together simulate a limb or joint. Each spacer cassette is removable and replaceable with an anatomy cassette that simulates an anatomy and or pathology in the limb or joint.

This application claims priority from AU2021902330 entitled Surgical training model filed on 29 Jul. 2021 the contents of which are hereby incorporated by reference in their entirety.

### TECHNICAL FIELD

The present invention relates to a surgical training model which can be used by surgeons, educators, trainers and or students in the healthcare and human sciences fields for the purpose of surgical training, teaching and learning.

### BACKGROUND

Surgical training models are fast becoming an adjunct to, and in some cases a replacement for cadavers and wet specimens in a wide range of demonstration and training environments.

Anatomy is considered the cornerstone of medicine. Cadavers and wet specimens have been an important gross anatomy teaching tool for many sciences and healthcare professions since the 15^{th} Century. In addition to teaching anatomy, in recent years, cadavers have replaced live patients in surgical training. However, ethical issues, harmful bacteria and availability as well as improved technology have seen a decline in the use of cadaveric materials in training, teaching and demonstrating environments.

In 2012, the International Federation of Associations of Anatomists (IFAA) made a recommendation that only cadavers acquired through voluntary donation be used for teaching, training and research. Considering a large number of countries rely on unclaimed bodies for these purposes, as well as the high cost of acquiring and storing cadavers, the development of effective teaching and learning alternatives are an important emerging industry. Anatomy models and virtual dissection software have supplemented and, in some instances, replaced cadavers and wet specimens in gross anatomy teaching labs all over the world. One study has found that anatomy models are the most effective gross anatomy teaching tool compared with virtual dissection software and even cadaveric material pro-section as stand-alone learning aids.

With the advent and advancement of 3-D printing (3Dp) or Additive Manufacturing (AM) technology, 3D printed models are being used to teach, plan and practice surgical procedures as well as provide better patient education. Unlike other manufacturing techniques, AM can utilise Magnetic Resonance Imaging (MRI) and Computed Tomography (CT) in the design process and/or CAD engineering programmes can be utilised to create anatomical shapes and test motional rotation and forces which results in detailed and anatomically correct replication of the anatomy, and in some cases, the production of functioning anatomical models. It has also led to the advent of tailored patient 3D models for surgical planning and rehearsal which decreases patient risk of iatrogenic injury, reduces surgical times and improves surgical outcomes for patients. In addition to tailored anatomical models, 3Dp enables manufacturers to produce custom pathologies within anatomy models including aneurysms, tumours and a variety of fracture patterns. These can be custom designed and manufactured to the client's specifications and needs.

A rapidly growing demand for surgical training models has emerged within the field of orthopaedic surgery, particularly for lower limb and upper limb fracture repair surgeries. Fracture patterns are diverse and occur on multiple sites. Depending on the location and severity of the fracture, unique surgical approaches are often required, thus the demand for anatomically correct models containing a variety of pathologies. Additionally, with the advancement of orthopaedic technologies, surgeons are frequently required to train on new technologies and products. The ability for surgeons to train on models up-skills surgeons without the need for them to learn and practice on live patients while still following the traditional tenet of surgical training, ‘see one, do one, teach one’.

In addition to 3D models producing better anatomy teaching outcomes, they can be easily obtained, transported, stored and reused. However, concerning the reuse of 3D models for teaching, this is not always the case for 3D models used for surgical planning or surgical teaching and practice. Once the models have been used, they are disposed of and need to be replaced. This is a very costly and wasteful exercise, particularly with larger anatomical models such as the lower limb. It also makes the routine use of large anatomically correct 3D models financially inaccessible to most healthcare and educational institutions. Not only does the expensive, disposable nature of the products limit the accessibility of invaluable, life-saving surgical practice aids, it also has an undesirable environmental impact.

Accordingly, there exists a need for improved surgical training model that reduces or at least ameliorates some of the problems of the prior art.

### SUMMARY OF INVENTION

In a first aspect there is provided a surgical training model comprising a plurality of removable spacer cassettes that when arranged together simulate a limb or joint, each spacer cassette being removable and replaceable with an anatomy cassette that simulates anatomy and or pathology in the limb or joint.

The interchangeable parts of the surgical training model will be referred to herein as “cassettes”. Cassettes containing detailed anatomy and or pathologies will be referred to herein as “anatomy cassettes”, and the cassettes optionally without detailed anatomy and without pathologies will be referred to herein as “spacer cassettes”.

The limb that is simulated can be a lower limb. The limb that is simulated can be an upper limb. In an embodiment, the limb is a leg. In an embodiment, the limb is selected from one or more of a leg, a hip, an arm or a shoulder. The limb or joint can be an animal limb or joint. The limb or joint can be a human limb or joint. In the following description a human limb is referred to since the surgeons training on the model are typically human surgeons that will operate on other humans. However, there is no reason that the invention described herein could not be applicable to veterinary surgeons who operate on animals.

The surgical training model can be a lightweight 3D printed replica of the human lower limb consisting of multiple lightweight spacer cassettes on multiple positions on the leg. These cassettes can be removed and replaced with anatomy cassettes of various sizes containing various anatomies or pathologies. When the anatomy cassettes have been used and removed, the lightweight spacer cassettes can be returned.

A few simulator training models with replaceable parts are available to purchase, i.e. parts that can be replaced after use. These include breast examination, catheterisation, arthroscopy, episiotomy and vasectomy simulators. At the time of writing and to the best of our knowledge, no anatomy or training model on the market has been designing with interchangeable parts, i.e., parts containing different anatomies or pathologies on the same model. Existing training or simulator models are made and sold, but only cater for the practice of one procedure, i.e., each procedure simulation requires a separate model.

At the time of writing and to the best of our knowledge, no 3Dp anatomy model manufacturers produce models with either replaceable or interchangeable parts. Limb and joint models are typically large, heavy, and costly to produce. Once the model has been used, it is disposed of. At the time of writing and to the best of our knowledge, a solution to reduce the cost and waste of limb/joint surgical training models does not exist.

The present surgical training model may, in embodiments, increase the versatility of the 3D training model, may reduce costs and in embodiments minimises the environmental impact by decreasing the volume of disposable parts. The reduction in production costs and the versatility provided by the model may make the surgical model more affordable and thus more accessible to healthcare industries, healthcare providers, surgeons, educators and students.

The surgical training model can be light weight. By light weight it is meant that the model can be readily carried by one person. Because the surgical training model is lightweight, in embodiments, it is easier to transport and store, and less expensive to ship than a full surgical model would be. The surgical training model once fully assembled can weigh less than about 20, 26, 14 or 12 kg. Each cassette can weigh at most about 5 kg, 4 kg, 3 kg, 2 kg, 1 kg or 500 g. A larger surgical training model of e.g. the full lower leg will weigh more than a smaller surgical training model of e.g. the human arm.

The surgical model can be 3D printed using advanced 3D printing techniques. The surgical model can be made using a combination of manufacturing technologies. The model is not necessarily made wholly using 3D printing techniques. The model can be prepared in standard sizes. The standard sizes can be based on a typical limb or joint size using average dimensions sourced from data gathered from a human population. For example, the average human arm is 25 inches, with male arms tending to be longer and heavier than female arms due to increased bone size and larger muscles. Every human is different. With this in mind, there can be various standard sizes of the limbs and joints prepared such as small, medium, large, X-large. The small limb may have a length of about 15 inches, the medium limb may have a length of about 18 inches, the large limb may have a length of about 20 inches and so on. The standard sizes can be varied according to design preferences and customer requirements as would be understood by the person skilled in the technical area. Alternatively, the limb or joint can be 3D printed or otherwise manufactured as a tailored model based on data taken from a subject patient. A tailored anatomical model may be preferred where the model is intended to be used in training for a specific surgical procedure on the subject patient.

The cassettes can be self-supporting once connected to one another. The cassettes can be arranged adjacent one another to complete the limb or joint. Each cassette can be coloured and shaped to simulate the inside and or outside of a human body. The cassette pieces can appear as a puzzle that have to be fitted together in the correct order so as to provide the overall realistic appearance of the limb or joint once assembled.

The spacer cassettes can be arranged to provide a complete looking limb or joint with simulation of the outside shape of the limb. The anatomy cassette is more detailed and can replace a spacer to simulate that the outside of the limb part or joint has been taken away so that an operation can be performed on the material underneath. The anatomy cassettes may appear like the inside of the human body with muscle fibres and arteries/veins, ligaments and bone as if a slice had been taken out of the limb or joint and replicated. With this in mind, the spacer cassettes are not necessarily 3D printed since they need only provide the underlying limb or joint structure for supporting the anatomy cassette. The anatomy cassettes are preferably 3D printed because of the level of detail and realism required during any surgical training procedures undertaken on the model.

The cassettes can each be marked e.g. by numbers to assist in their assembly together with one another. The markings on the cassettes can be sequential so as to make it clear in which order the cassettes should be joined with one another. The markings can also assist the user to determine which way up an anatomy cassette should be inserted relative to the spacer cassettes provided.

Once the cassettes are located into position relative to one another, in embodiments, the limb or joint can be moved about any joint(s) present so as to simulate natural limb movement. The limb can be provided together with a joint. Each limb might have multiple joints e.g., lower limb has hip, knee and or ankle. Each spacer cassette can be securely attached to an adjacent cassette once in position. The removable attachment of spacer cassettes to one another can be by complementary attachment locations. The complementary attachment locations can be one or more of clips, magnets, adhesive or other. In an embodiment, each spacer cassette has an attachment location at each of its ends. The attachment location can be a strong, rigid plate on either end of the cassette that can comprise protrusions which can be inserted into a vacant position on a strong, rigid plate of an adjacent cassette. The protrusions and vacant positions can be dove-tail joints or similar engaging fasteners which holds each cassette in the limb or joint into position relative to one another. The rigid plate can be formed integrally with the cassette. The rigid plate can be formed separably to the cassette and joined with it afterwards to provide an integral piece.

Each spacer cassette is removable independently of the other cassettes. Each spacer cassette can be replaceable by an anatomy cassette. The anatomy cassettes can each represent a particular anatomy or a pathology. Replacement and interchangeable cassettes can be customised or tailored and made to order according to the needs of the client without the need for additional parts. The present surgical model, in embodiments, allows anatomies including bone structure, ligament structures, any unusual healing, shaping or congenital defects to be inserted into the model without the need for a new model to be produced. The present surgical model, in embodiments, allows pathologies including multiple fracture patterns to be inserted at multiple locations at the appropriate placement on the model without the need for an entirely new model to be produced for every fracture location or other pathology.

The anatomy cassette can simulate a pathology, disease, deformity, dislocation, fracture or injury of any kind including a lodged foreign body, or any alignment that can cause limb/joint pain. The pathologies can include any maladaptation of the limb or joint that requires a surgical procedure to correct. The pathology can be selected from one or more of a fracture, an aneurysm, a tumour, and a lodged foreign body. Before the advent of sterile surgical conditions and techniques, physicians stabilised fractures using external casts and splints. Now, internal fixation using implants such as plates, screws, and wires is common practice. Each fracture type and classification requires its own unique approach. Fracture locations in the lower limbs include distal femur, femoral head, femoral shaft, proximal tibia, distal tibia and tibial shaft, as well as different locations on the fibula, or a combination of fracture sites. Fracture locations in the upper limbs include humerus, radius and ulna fractures or a combination of fracture sites. Each aneurysm type and classification requires its own unique approach. Aneurysm locations can be at any location along the limb where arteries and veins travel.

Each tumour type and classification requires its own unique approach. Tumour locations can be at any location in the limb where there is tissue. Foreign bodies can become lodged in the limb for any reason. Foreign bodies include bullets and nails that sometimes become lodged in the limb by accident. In addition to pathologies, as noted above, various anatomies can be simulated be they commonplace or unusual.

Cassettes can be developed for revision surgery, where an original surgical operations needs to reworked due to complication or wear and tear. A number of the same cassette can be produced for more than one approach to the surgery to be tried and tested. Cassettes can also be developed to provide training for new tools or implants that are constantly evolving.

The anatomy cassette can fit into the location of the removed spacer cassette and be firmly locked into position. In an embodiment, the anatomy cassette can be attached to the spacer cassettes using the same attachment location means as described above. Optionally, a different attachment is provided so long as iti s engageable with the spacer cassette in some way that allows it to co-exist with the spacer cassette during use. Anatomy cassettes can be inserted at the joints of the limb (elbow, wrist, ankle, knee), at various positions along the shafts of the limb bones, at the proximal and distal ends of each of the limb bones or a combination of cassettes can be inserted at different locations at the same time. The anatomy cassette and remaining spacer cassettes do not move relative to one another once in position so that any surgical procedure performed on the simulated limb is not hampered by unrealistic movement of sections or parts. However, the anatomy cassette, once inserted, may allow the limp or joint that it forms to have a full range of normal motion representing human limb or joint motion.

In an embodiment a large anatomy cassette can be manufactured as one cassette piece to provide a larger surgical dissection region. The larger single anatomy cassette may replace two or more of the spacer cassettes in any combination.

Once the anatomy cassette has been used (i.e. dissected, operated upon, otherwise irreversibly destroyed), it can be removed and stored or disposed of. A spacer cassette with the same plates on either end can be inserted back in its place or it can be replaced by another anatomy cassette for another use. The limb is infinitely reusable as spacer cassettes and anatomy cassettes are switched into and out of position as required.

Also provided is a system providing training of a surgical procedure, the system comprising
obtaining details optionally from a patient regarding the dimensions of their limb or joint and the location(s) of one or more anatomies or pathologies in the limb or joint;
providing a 3D printed surgical training model comprising a plurality of spacer cassettes as herein described based on the patient's dimensions or other standard dimensions,
locating anatomy cassette(s) in the 3D printed surgical training model at the location(s) of the one or more anatomies or pathologies by replacing spacer cassette(s) with the anatomy cassette(s).

In an embodiment, a surgical training procedure is related to an unusual knee structure. The details about this knee structure may originate from an actual patient, but the details for creation of the present surgical model are simulated using off the shelf software that can generate a limb of an average person. A plurality of spacer cassettes can be manufactured to provide a limb. The limb can be made up from a plurality of spacer cassettes but once they are all fitted together, it looks like one whole limb. The unusual knee anatomy can be 3D printed as a knee joint cassette. The spacer cassette of the limb that is at the location of the knee joint can be removed. The anatomy cassette 3D printed with the knee anomaly can be inserted into the limb. More than one limb that is identical to the one described in this paragraph can be prepared. This means that multiple surgical models could be provided for a surgical training day or an exam in the knowledge that each limb is the same as the other so no one person is disadvantaged or has an advantage.

In another embodiment, a surgical training procedure is related to a tumour in a shoulder joint. The details about this tumour may originate from an actual patient, but the details for creation of the present surgical model can be simulated using off the shelf software that can generate a shoulder joint of an average person. A plurality of spacer cassettes can be manufactured to provide a joint attached to the limb. The joint and limb can be made up from a plurality of spacer cassettes but once they are all fitted together, it looks like one whole shoulder and arm limb. The pathology can be 3D printed as a shoulder joint cassette. The spacer cassette of that is at the location of the shoulder joint can be removed. The anatomy cassette 3D printed with the shoulder anomaly can be inserted into the model. More than one model that is identical to the one described in this paragraph can be prepared. This means that multiple surgical models could be provided for a surgical training day or an exam in the knowledge that each limb is the same as the other so no one person is disadvantaged or has an advantage.

Furthermore, once each of the models described above has been used, the anatomy cassette of interest can be removed. The spacer cassette can be placed back into the model. The model can then be stored until it is required for use again. The next time the model is used, it may have a different anatomy cassette simulating a different anatomy or pathology.

### BRIEF DESCRIPTION OF THE FIGURES

Embodiments of the invention will now be described with reference to the accompanying drawings which are not drawn to scale and which are exemplary only and in which:

FIG. 1A and FIG. 1B are lateral perspective views of a surgical training model in an embodiment in which the model is of a lower limb including the knee.

FIGS. 2A, 2B and 2C are a lateral schematic view of the surgical training model of FIG. 1 showing the possible locations of spacer cassettes and anatomy cassettes.

FIGS. 3A, 3B and 3C are anterior perspective views showing some of the cassettes of the model of FIG. 2 in exploded view.

FIGS. 4A and 4B are a close-up views of the joint between two cassettes in FIG. 3 showing an embodiment of an attachment mechanism.

FIG. 5 is an alternative embodiment in which the cassettes are mounted on a base.

FIGS. 6A and 6B are alternative embodiment to the one shown in FIG. 4 in which a different attachment mechanism is shown.

FIGS. 7A and 7B are side view perspective views of a surgical training model in an embodiment in which the model is of an upper limb including the elbow.

FIG. 8 shows a plan view of different cassette pieces that could be prepared.

FIG. 9 shows a plan view of how cassette pieces can be fit together to form a limb.

FIG. 10 shows a lower limb with an anatomy cassette at the knee joint. The limb is movable about a pivot point.

FIG. 11 is a different view of the limb of FIG. 10.

FIG. 12 is a perspective view of an anatomy cassette which in this embodiment is a knee.

FIG. 13 is a bottom view of the cassette of FIG. 12.

FIG. 14 is a first end view of the cassette of FIG. 12.

FIG. 15 is a second end view of the cassette of FIG. 12.

FIG. 16 is a top view of the cassette of FIG. 12.

FIG. 17 is a lateral view of the cassette of FIG. 12 with the knee joint bent.

### DETAILED DESCRIPTION OF EMBODIMENTS OF THE INVENTION

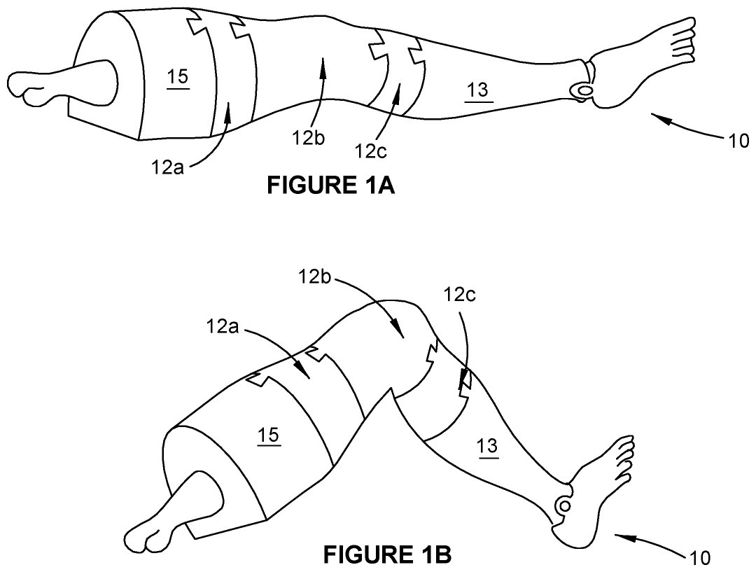

FIG. 1 shows an embodiment of a surgical training model 10 comprising a plurality of removable spacer cassettes 12 that when arranged together simulate a human limb which in this embodiment is a leg. Each spacer cassette 12 is removable and replaceable with an anatomy cassette 14 that simulates a pathology in the human limb. Each spacer cassette can have the appearance of solid external skin.

In FIG. 1, there is shown for exemplary purposes three spacer cassettes 12a, 12b, 12c. There is also shown the lowermost cassette 13 which is the lower part of the leg including a foot. The uppermost cassette 15 is the top part of the model and has a bone showing in the location at which the bone would protrude from a leg. The bone can be modified into a ball joint for use as described further below. The lowermost cassette 13 and the uppermost cassette 15 each have an attachment location at one end to allow the joining of cassettes in series.

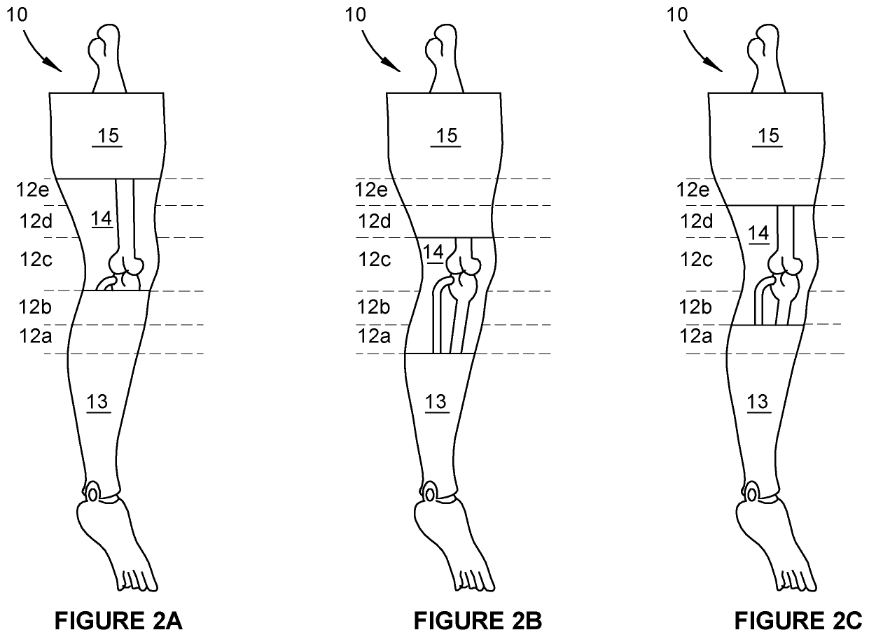

The surgical training model 10 of the embodiment of FIG. 2 is a lightweight 3D printed replica of a human lower limb consisting of multiple lightweight spacer cassettes 12 on multiple positions on the leg. The arrangement in FIG. 2 is similar to the embodiment of FIG. 1, although now there are locations for five spacer cassettes 12a to 12e. These cassettes 12a to 12e can be removed and replaced with anatomy cassettes 14 of various sizes containing various pathologies. In embodiments, cassettes 13 and 15 can also be spacer cassettes.

In FIG. 2A, spacer cassettes 12c, 12d and 12e have been removed and replaced with anatomy cassette 14. In FIG. 2B, spacer cassettes 12a, 12b and 12c have been removed and replaced with anatomy cassette 14. In FIG. 2C, spacer cassettes 12b, 12c and 12d have been removed and replaced with anatomy cassette 14.

Each of the anatomy cassettes 14 has a different location of pathology or anatomical issue of interest. The choice of location of the anatomy cassette can depend on where the pathology is on an actual patient or where a simulated anatomy or pathology is desirable. For example, a patient with a pathology or anatomical issue of interest relating to the femur could use the anatomy cassette 14 of FIG. 2A. A patient with a pathology or anatomical issue of interest relating to the tibia could use the anatomy cassette 14 of FIG. 2B. A patient with a pathology or anatomical issue of interest relating to the knee could use the anatomy cassette 14 of e.g. FIG. 2C. For example, a surgeon wanting to train a student on a pathology or anatomical feature of interest can also design his own anatomy cassette for insertion into the relevant place into the model.

The health practitioner could work on the anatomy cassette 14 by e.g. undertaking a procedure. The practice on the cassette 14 might allow the practitioner to become familiar with the way in which to approach the pathology. Alternatively, or in addition, it might allow them to try various approaches to see what would work best. The practice on the cassette 14 might allow them to show another practitioner or train another practitioner on how to work on the particular pathology. When the anatomy cassette 14 has been used, it can be removed and the relevant spacer cassettes 12 can be returned. Alternatively, a new anatomy cassette 14 can be inserted ready for the next procedure.

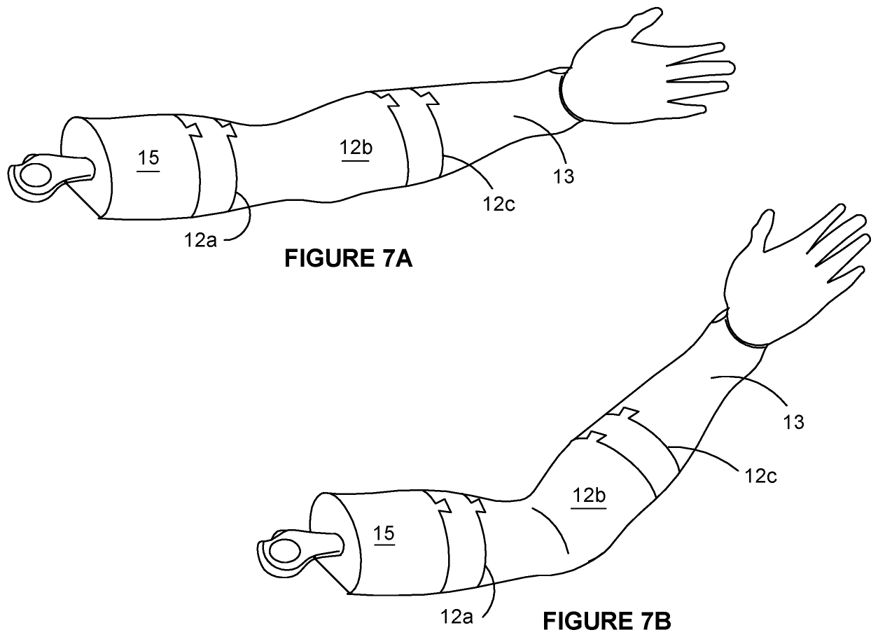

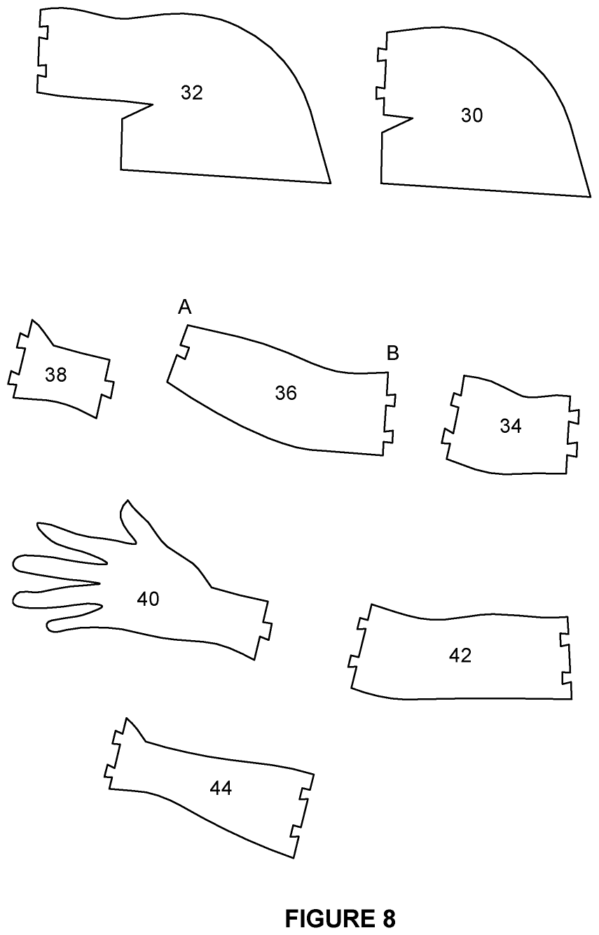

In order to increase the realism of the model 10, the cassettes 12, 13, 14 and 15 of the model can be 3D printed or a combination of manufacturing technologies can be employed. Each cassette can be manufactured according to a required set of dimensions so that the overall limb once assembled is the required size. A small female limb might have cassettes that are relatively smaller in all dimensions when compared to a large male limb. The lower most cassette 13 can include additional features such as a foot (as shown in e.g. FIG. 1) or a hand if the limb is an arm (e.g. FIG. 7). The uppermost cassette 15 can include the hip or shoulder part of the body that the limb would extend from. In some embodiments, a spacer cassette located at the hip or shoulder, wrist or ankle can be replaced by an anatomy cassette. Once the cassettes 12, 13, 14, 15 are located into position relative to one another, in embodiments, the limb 10 can be moved about any joint(s) present so as to simulate natural limb movement. Optionally, each spacer cassette can be coloured/decorated to provide a realistic experience of a removed body part. The surface of the cassette can be plain in colour, white of skin tone.

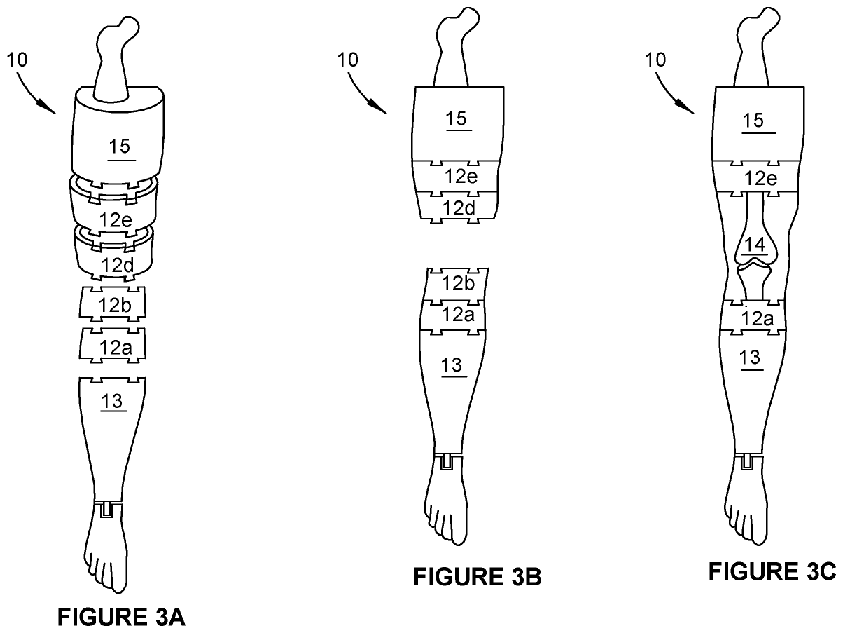

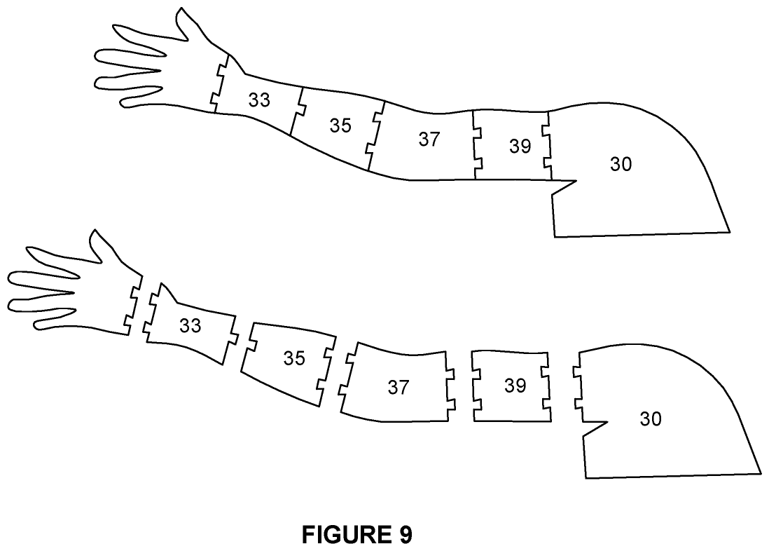

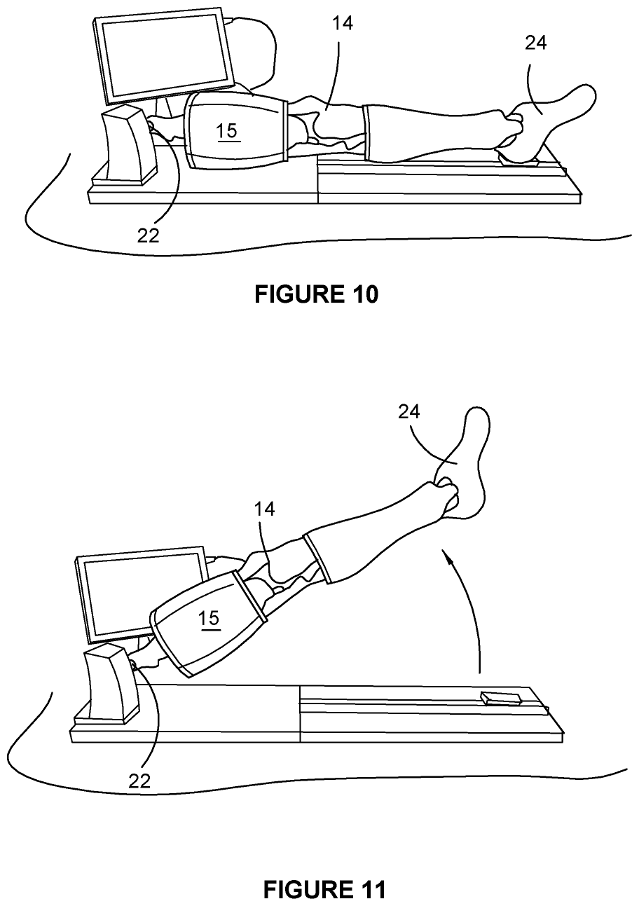

In FIG. 7, there are shown cassettes 12a, 12b, 12c which are functional equivalents to those of the leg of FIG. 1 only now they are forming an arm. There is also shown the lowermost cassette 13 which is the lower part of the arm including a hand. The uppermost cassette 15 is the top part of the model arm and has a bone showing in the location at which the bone would protrude from the arm. This bone can be a ball joint for use as described further below in respect of FIG. 10. The lowermost cassette 13 and the uppermost cassette 15 each have an attachment location at one end to allow the joining of cassettes in series. FIGS. 8 and 9 show one option for all the different parts that can be provided to build an upper limb. There can be a shoulder cassette 30, a shoulder plus humerus cassette 32, an elbow cassette 34, an elbow plus radius cassette 36, a wrist cassette 38, an elbow plus humerus cassette 42, radius plus wrist cassette 44 (Also hand 40). Any one of these pieces can replace one or more of the spacer cassettes in FIG. 7 or FIG. 9. For example, spacer cassette 12b of FIG. 7 could be replaced with the elbow plus radius cassette 36. For example, shoulder plus humerus cassette 32 could replace two of the spacer cassettes in FIG. 9. In the embodiments shown in FIG. 3, the cassettes 12, 13, 14, 15 are self-supporting once connected to one another. By self-supporting it is meant that the cassettes do not require any other structural support to hold them together other than the fact that they attach to one another.

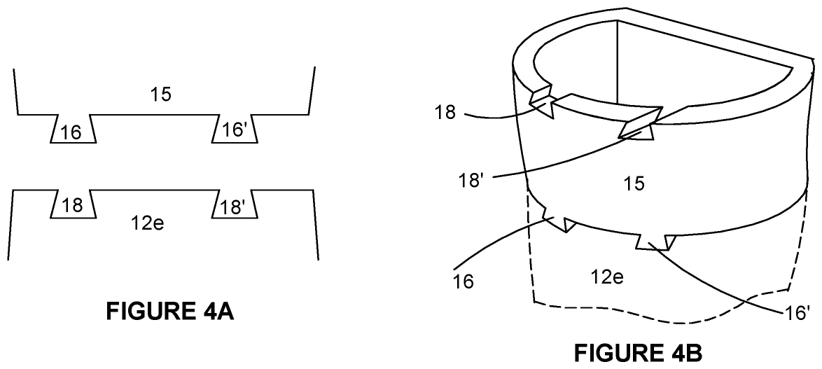

In FIG. 3A, the cassettes 15, 12e, 12d, 12b, 12a, 13 are shown in exploded view. (Cassette 12c which would be in the middle of the series around the knee joint has been removed). In FIG. 3B the lower cassettes 13, 12a and 12b have been joined together to form a part of the limb 10. The upper cassettes 15, 12e and 12d have been joined and attached to one another to form the top part of the limb 10. This is shown in close up in FIGS. 4A and 4B where the attachment locations are shown more clearly. To insert anatomy cassette 14, cassettes 12b and 12d are removed and the anatomy cassette 14 is attached in their place. The limb 10 is now ready for use in FIG. 3C.

As can be seen in e.g. FIG. 3, the pieces of the limb 10 may appear as a puzzle that have to be fitted together in the correct order so as to provide the overall realistic appearance of the limb 10. The cassettes 12, 13, 14, 15 can be marked so that the user knows in which order they should be placed. There can also be instructions provided with the model to allow the user to understand how to construct and deconstruct the limb 10.

The attachment of the uppermost cassette 15 to the spacer cassette 12e is shown as two dove-tailed joints 16, 18. This is shown in close up in FIG. 4A. Noted for their resilience to pull apart, these finger-like dovetail joints between two pieces of material can enable a tight interference fit. In order to assemble the joint between two cassette pieces, extensions or tounges16, 16′ on first end of e.g. cassette 15 are slid into the channels or grooves 18 and 18′ on second end of cassette 12e, respectively. Once in place, the two cassettes 15 and 12e joined first end to second end cannot be pulled apart along the longitudinal axis of the limb 10. It should be understood that there can be more or less than 2 dovetail joints (tongue and groove joints) per cassette pair. Each dovetail joint can be formed integral with its respective cassette during manufacture. Alternatively, the cassette can be formed and then end plates can be attached to either side of the cassette to provide the dove tail parts. If necessary, there can be releasable locking means for preventing or reducing separation of the cassettes once joined.

Each spacer cassette can have a first end A and a second end B as shown in FIG. 8. Some spacer cassettes 12 can have a tongue protrusion at a first end A, and a groove or channel at the second end B. This alternating arrangement will allow for multiple spacer cassettes to connect to one another in series as shown in FIG. 7. Alternatively, some spacer cassettes have tongue like protrusions at both the first end A and the second end B. For example, spacer 34 and 38 and 42 in FIG. 8; and spacers 33 and 37 in FIG. 9. Some spacer cassettes will have grooves at both the first end A and the second end B. For example, spacers 35 and 39 in FIG. 9. Where the spacer cassettes have like type attachment locations at each of the first and second ends A, B, only some of the spacer cassettes may be replaceable.

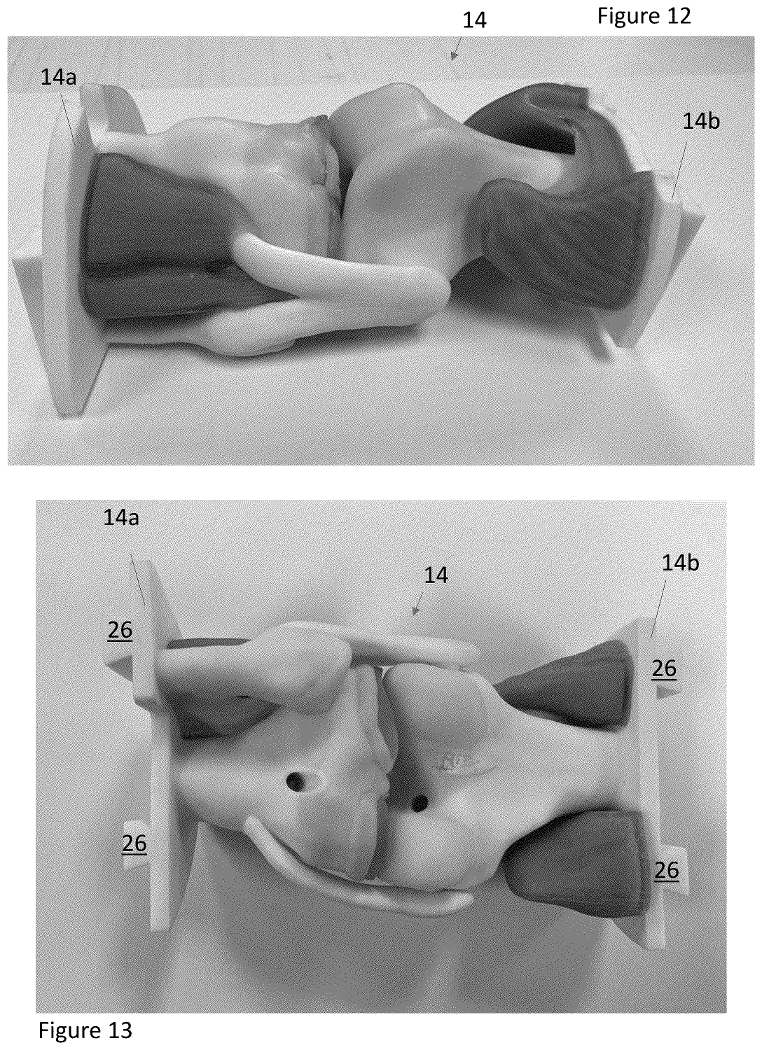

It can be advantageous to have the arrangement shown in FIG. 9 where only some spacer cassettes 33, 37 are replaceable by anatomy cassettes with tongues at each end. Since each replaceable spacer cassette 33, 37 has only tongue protrusions, each anatomy cassette can be provided with only the tongue parts as attachment means (see FIG. 12 onwards). These tongue parts 26 can mate into the grooves of adjacent spacer cassettes 12. Providing an anatomy cassette 14 with grooves can be inconvenient due to the size and shape of the anatomy cassette 14 and that it must be realistic so that cut-out parts may not be accommodatable.

Each spacer cassette 12 is removable independently of the other cassettes 12-15. Each spacer cassette 12 can be replaceable by an anatomy cassette 14. The spacer cassette 12 in e.g. FIG. 4 is shown as hollow, but it should be understood that while any of the cassettes can be hollow, they can also be formed as solid non-hollow pieces. A spacer cassette can be hollow since it simply provides the structure of the model. An anatomy cassette is not hollow because it shows the realistic internal structures of anatomy. Each anatomy cassette 14 can represent a pathology or an anatomical feature of interest.

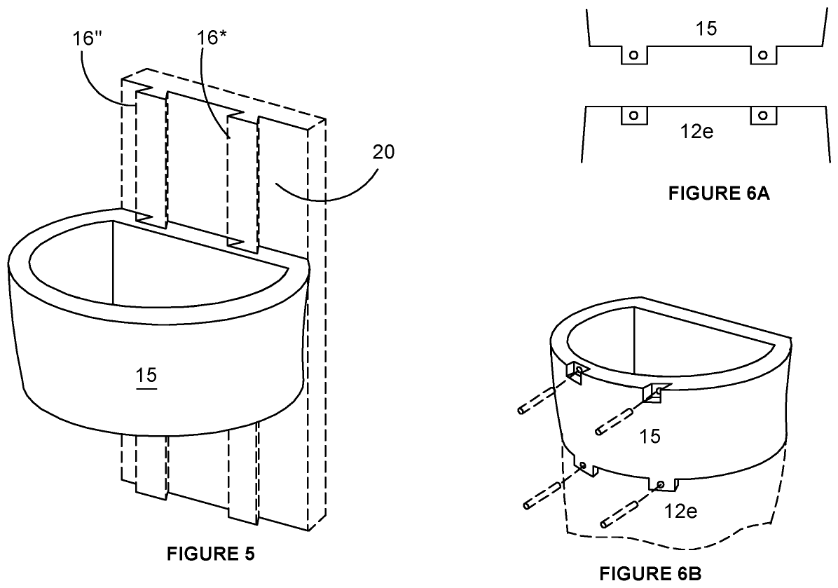

In one embodiment, the model 10 can comprises a base 20 that is used to support the plurality of cassettes 12-15. The base 20 can be a housing, platform, support or container into which the cassettes can be fitted. The base 20 can comprise a shelf onto which the cassettes can be arranged adjacent one another. In FIG. 5, the base 20 is shown as a support 20 having extensions 16″, 16*. The extensions 16″, 16* can be used to connect with the channels 18, 18′ on the cassettes 12-15. Alternative to what is shown the cassette 12-15 can comprise the extensions 16 and the base can comprise the channels 18. Each cassette 12-15 can be slid into position in series to from the limb or joint 10. Preferably the base is bendable and flexible to allow the limb or joint to move in the same way that a natural limb would move. A disadvantage to a base is that it can inhibit some movement and thus it may not be appropriate for some of the surgical models, particularly joints. A further disadvantage of a base is that in order to replace the spacer cassettes 12 with anatomy cassettes each one has to be removed and then replaced. However, it should be understood that this arrangement is within the spirit and scope of the invention.

In an embodiment, the upper part of a limb and lower part of a limb may be mounted e.g. via a ball joint to a metal, wood, plastic or composite base to allow free range of motion from a fixed position around the ball joints rotational axis. As can be seen in FIG. 10 and FIG. 11, the upper spacer 15 can be mounted at location 22. The foot 24 can slide along the base as the joint 14 is moved to provide realistic motion. Optionally, the foot can be lifted just like a real leg. Alternatively, both an upper limb and or a lower limb may be jointed to a manufactured abdomen or thorax to provide an even more realist experience (not shown).

While dovetails are shown in e.g. FIG. 4, it should be understood that the attachment of the cassettes 12-15 to base 20 or to another cassette 12-15 can be by any complementary attachment locations. The complementary attachment locations can be locking pins 22 that pass through a passageway 24 that forms when the cassettes 12-15 are brought into mating connection with one another as shown in e.g. FIGS. 6A and 6B.

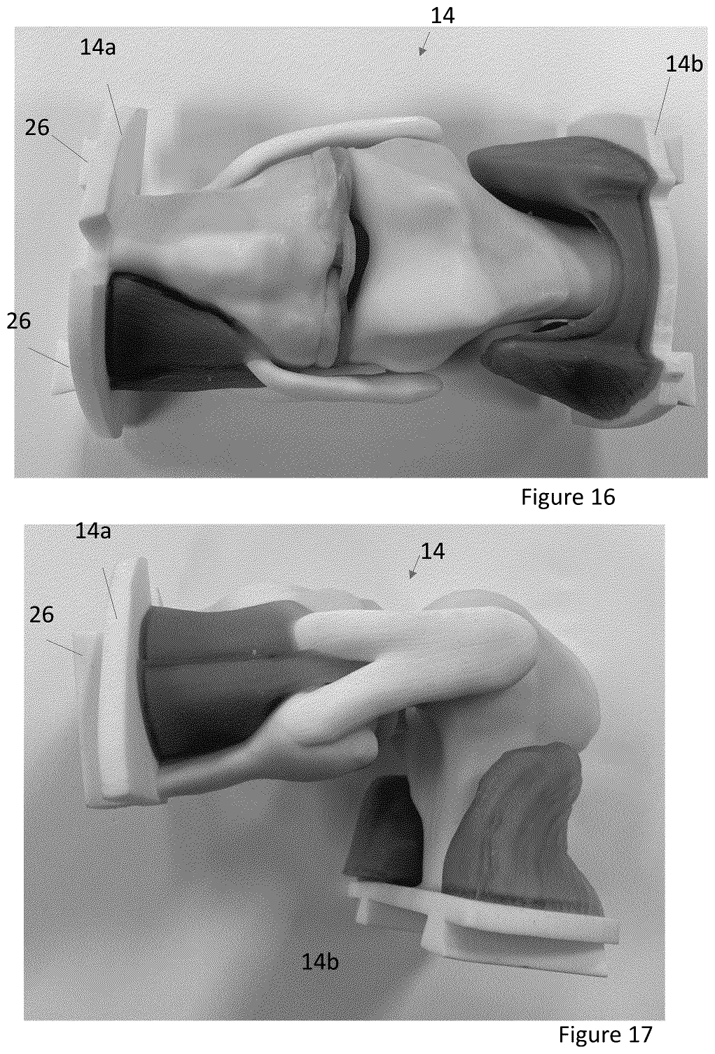

FIGS. 12 to 17 shown an embodiment of an anatomy cassette 14 which is a knee joint. The knee joint bending is shown in FIG. 17. The realistic bone and ligament structures should be clear from the enclosed drawings. Each anatomy cassette 14 is shown having a first end 14a and a second end 14b, the first end 14a and second end 14b each having an attachment means so that the second end 14b of an anatomy cassette 14 is attachable to a first end of an adjacent spacer cassette 12. The attachment means is a tongue 26 which can fit into groove 18 provided on the spacer cassette 12.

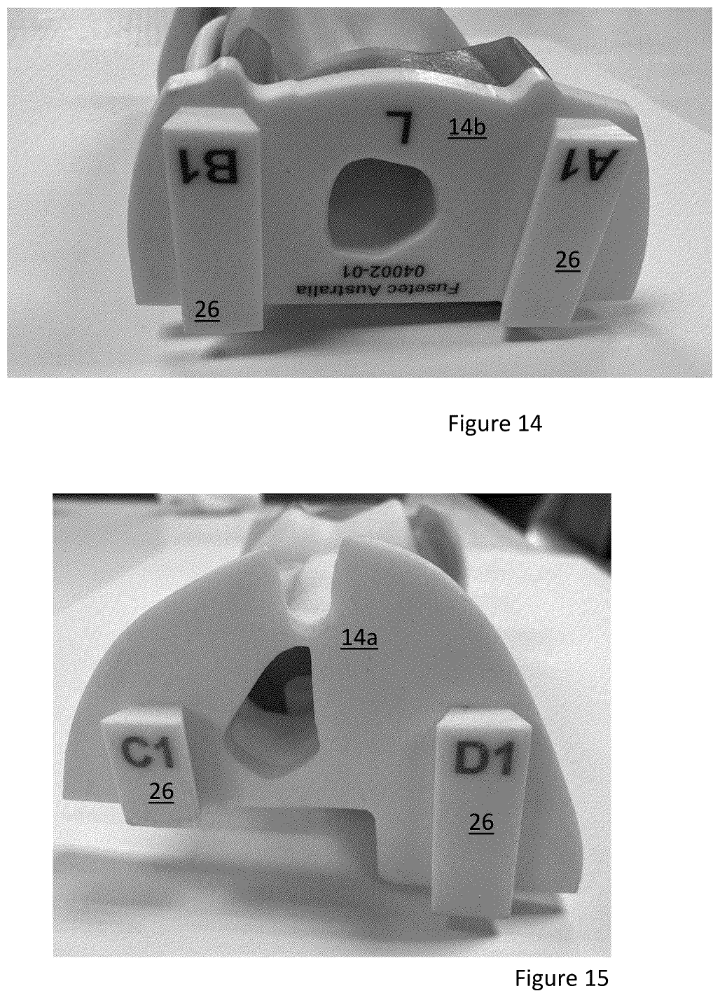

The tongue part 26 of the attachment means can be provided on a plate 14a 14b which can be best seen in FIG. 14 or FIG. 15. As shown in those Figures, there can be at least two tongue parts 26 provided along the entire span of the first end 14a and or the second end 14b.

It is to be understood that, if any prior art publication is referred to herein, such reference does not constitute an admission that the publication forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

Any promises made in the present description should be understood to relate to some embodiments of the invention and are not intended to be promises made about the invention as a whole. Where there are promises that are deemed to apply to all embodiments of the invention, the applicant/patentee reserves the right to later delete them from the description and does not rely on these promises for the acceptance or subsequent grant of a patent in any country.

1. A surgical training model, comprising:
a plurality of removable spacer cassettes that when arranged together simulate a limb or joint, each spacer cassette being removable and replaceable with an anatomy cassette that simulates an anatomy and or pathology in the limb or joint.

2. The model of claim 1, wherein at least each anatomy cassette is 3D printed.

3. The model of claim 1, wherein each spacer cassette is removably attachable to an adjacent spacer cassette or adjacent anatomical cassette to provide a simulated human limb or joint with a substantially full range of natural movement.

4. The model of claim 3, wherein each spacer cassette comprises a first end and a second end, the first end and second end each having an attachment location so that the second end of a first spacer cassette is attachable to a first end of an adjacent second spacer cassette, wherein the first end attachment location and the second end attachment location is a groove.

5. The model of claim 4, wherein each anatomy cassette comprises a first end and a second end, the first end and second end each having an attachment location so that the second end of an anatomy cassette is attachable to a first end of an adjacent spacer cassette, wherein the first end attachment and the second end attachment location is a tongue.

6. The model of claim 5, wherein at least the tongue part of the attachment location is provided on a plate at the first end and or the second end.

7. The model of claim 6, wherein there are at least two tongue parts provided along the entire span of the first end and or the second end.

8. The model of claim 1, wherein the limb has an upper end that is pivotably connected to a pivot mount.

9. The model of claim 1, wherein each spacer cassette is hollow.

10. The model of claim 1, wherein each anatomy cassette is provided with one or more of a pathology, disease, deformity, dislocation, fracture or injury of any kind including a lodged foreign body, or any alignment that can cause limb/joint pain.

11. The model of claim 1, wherein the model is a tailored anatomical model based on patient dimensions and each anatomy cassette simulates a specific anatomy, pathology, disease, deformity, dislocation, fracture or injury of any kind including a lodged foreign body, or any alignment that can cause limb/joint pain, that could be subject to surgical intervention.

12. A kit, comprising:
a plurality of removable spacer cassettes that when arranged together simulate a limb or joint, an anatomy cassette that simulates an anatomy and or pathology in the limb or joint the parts once assembled forming the surgical training model according to claim 1.

13. A method of providing training of a surgical procedure, comprising:
providing a surgical training model comprising a plurality of removable spacer cassettes that when arranged together simulate a limb or joint, each spacer cassette being removable and replaceable with an anatomy cassette that simulates an anatomy and or pathology in the limb or joint;
providing or procuring at least one 3D printed anatomy cassette simulating an anatomy or a pathology; and
locating the anatomy cassette into the surgical training model at the location(s) of the one or more anatomies or pathologies by replacing spacer cassette(s) with the anatomy cassette.

14. The method of claim 13, further comprising operating or allowing others to perform an operation on the anatomy cassette.

15. The method of claim 13, further comprising obtaining details regarding the dimensions of a limb or joint and the location(s) of one or more anatomies or pathologies in the limb or joint optionally from a patient.

16. The method of claim 14, further comprising obtaining details regarding the dimensions of a limb or joint and the location(s) of one or more anatomies or pathologies in the limb or joint optionally from a patient.
